(19) United States
(12) Patent Application Publication
(10) Pub. No.: US 2009/0310179 A1
(43) Pub. Date: Dec. 17, 2009

(54) INFORMATION PROCESSING APPARATUS USING LICENSE INFORMATION, METHOD, AND CONTROL PROGRAM

(75) Inventor: Yuu Tamura, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/482,347

(22) Filed: Jun. 10, 2009

(30) Foreign Application Priority Data
Jun. 13, 2008 (JP) 2008-155356

(51) Int. Cl. G06F 3/12

(52) U.S. Cl. 358/1.15

(57) ABSTRACT

An information processing apparatus configured to communicate with an image forming apparatus is provided. The information processing apparatus includes a receiving unit configured to receive destination information transmitted from the image forming apparatus, a destination determining unit configured to determine the destination of the image forming apparatus by using the destination information transmitted to the receiving unit, a totalizing unit configured to totalize a number of image forming apparatuses associated with the determined destination, an operating-environment determining unit configured to determine the current operating environment based on the number of image forming apparatuses totalized by the totalizing unit, and a function limiting unit configured to limit at least one function of a program presented to the image forming apparatus based on the current operating environment determined by the operating-environment determining unit.

### BACKGROUND OF THE INVENTION

1. Field of the Invention

The present invention relates to an information processing apparatus managing various kinds of programs.

2. Description of the Related Art

There have been applications which vary on a destination-by-destination basis. For example, there have been applications destined for Japan so that the applications are distributed in Japan, and there have been applications destined for the USA so that the applications are distributed in the USA. Some of the above-described applications are to be used only when the destinations of the applications agree with the actual operating environments.

For managing the contents of a digital versatile disk (DVD), the following mechanism has been proposed. According to the above-described mechanism, a global positioning system (GPS) terminal is installed in a DVD reproducing device, so as to specify the area where the DVD reproducing device is actually used. Then, the reproduction of a DVD-Video disk appropriate for the area is permitted (refer to Japanese Patent Laid-Open No. 11-161486).

In recent years, awareness among the public about security has been growing due to the progression of networks and increasing multifunctionality of terminals. Therefore, there has been proposed a mechanism which allows for encoding secret data and decoding the encoded data only in predetermined bounds.

### SUMMARY OF THE INVENTION

According to one aspect of the present invention, an information processing apparatus configured to communicate with an image forming apparatus is provided. The information processing apparatus includes a receiving unit configured to receive destination information transmitted from the image forming apparatus, a destination determining unit configured to determine the destination of the image forming apparatus by using the destination information received by the receiving unit, a totalizing unit configured to totalize a number of image forming apparatuses associated with the determined destination, an operating-environment determining unit configured to determine the current operating environment based on the number of image forming apparatuses totalized by the totalizing unit, and a function limiting unit configured to limit at least one function of a program presented to the image forming apparatus based on the current operating environment determined by the operating-environment determining unit.

Other features and advantageous of the present invention will be apparent from the following description taken in conjunction with the accompanying drawings, in which like reference characters designate the same or similar parts throughout thereof.

### BRIEF DESCRIPTION OF THE DRAWINGS

FIG. 1 is a module diagram for a personal computer (PC) and an image processing apparatus, and shows an exemplary system configuration.

FIG. 2 shows an exemplary module configuration of a server according to an embodiment of the present invention, which corresponds to the PC shown in FIG. 1.

FIG. 3 shows exemplary processing procedures performed to acquire data of the destinations of devices provided on a network and limit the functions of the server based on the destinations of the devices.

FIG. 4 shows an exemplary list of the number of devices and prohibited destinations.

FIG. 5 shows another exemplary list of the number of devices and the prohibited destinations.

FIG. 6 shows an exemplary modification of the processing procedures shown in FIG. 3.

FIG. 7 shows another exemplary list of the number of devices and the prohibited destinations.

FIG. 8 shows exemplary processing procedures performed to transmit data of a key used to restart the functions of the server when the functions of the server are stopped.

FIG. 9 is an exemplary flow of processing procedures performed to restart the functions of the server by using data of a stop cancellation key.

FIG. 10 is an exemplary flow of processing procedures performed to specify the destination of a device.

FIG. 11 shows an exemplary product name-destination correspondence list.

FIG. 12 shows an exemplary module configuration of a server.

### DESCRIPTION OF THE EMBODIMENTS

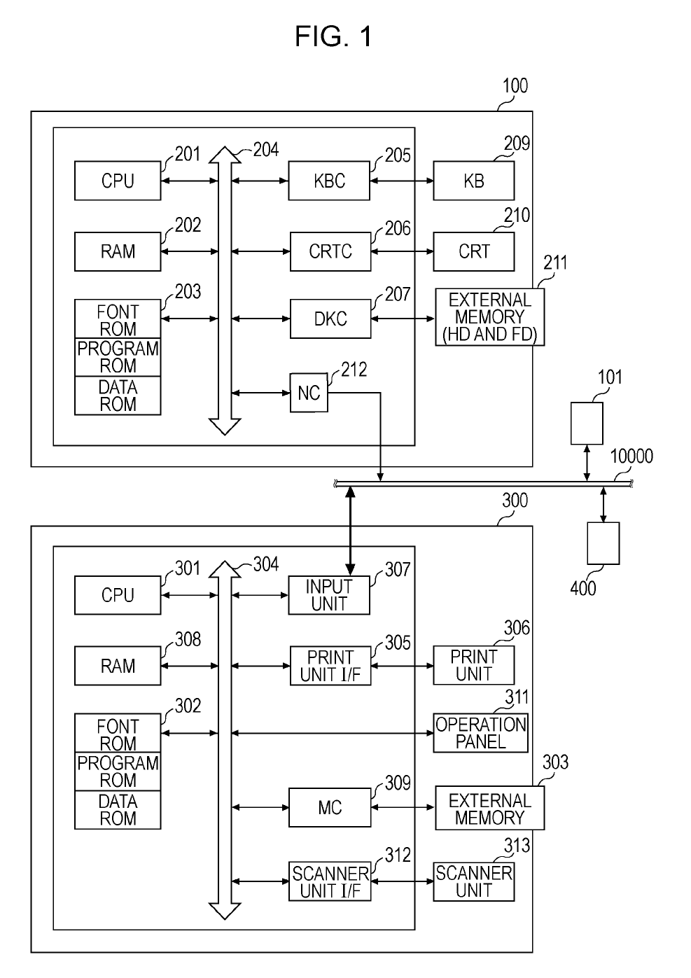

An image processing system according to a first embodiment of the present invention includes a personal computer (PC) 100 and an image forming apparatus 300 that are configured, as shown in FIG. 1.

In FIG. 1, the PC 100, that is, a host computer 100, the image forming apparatus 300, and so forth are connected to one another in a communicable manner via a network 10000.

PC 100 may be referred as server 4000 or server 2000 in the following paragraphs.

First, the configuration of the computer 100 will be described. Here, a hardware block diagram shown in FIG. 1 is equivalent to that of a widely used information processing apparatus. FIG. 1 shows the computer 100, which is an exemplary information processing apparatus according to the first embodiment.

In FIG. 1, a central processing unit (CPU) 201 executes programs including an OS, an application, and so forth, the programs being stored in a program read only memory (ROM) of a ROM 203, or loaded from a hard disk 211 to a random access memory (RAM) 202. Here, the term “OS” is an abbreviation for an operating system running on the computer. Hereinafter, the operating system will be referred to as an OS. Processing procedures shown in flowcharts that will be described later are achieved by executing the above-described programs. The RAM 202 functions as the main memory, the work area, and so forth of the CPU 201. A keyboard controller (KBC) 205 controls data input through a keyboard 209 and/or a pointing device (not shown). A cathode-ray tube (CRT) controller (CRTC) 206 controls data displayed on a CRT display 210. A disk controller (DKC) 207 controls access to various kinds of data stored in a hard disk (HD) 211, a floppy (Registered Trademark) disk (FD), and so forth. A network control (NC) 212 is connected to the network and executes processing, so as to control communications between the computer 100 and other devices connected to the network. Namely, the NC 212 transmits and/or receives print data, and receives destination information, for example.

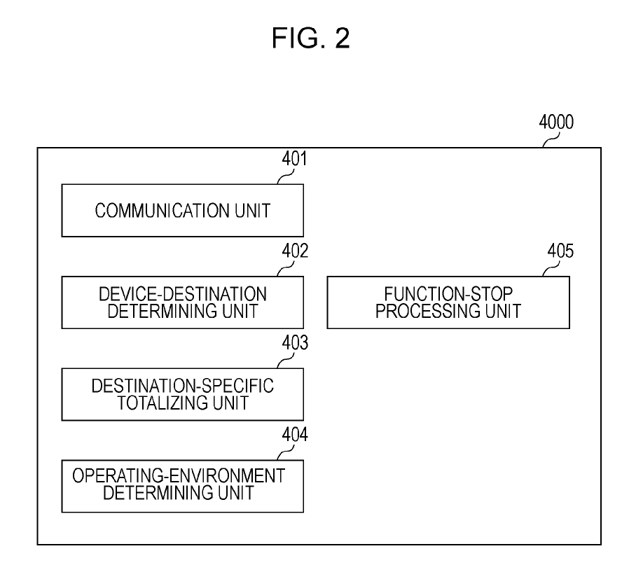

A computer 101 has the same configuration as that of the computer 100. Various data programs shown in FIGS. 2 and 12 are stored in an external memory 211 of the computer 100. Then, the CPU 201 reads the above-described various data programs out to the RAM 202, and executes the programs.

Next, the configuration of the image forming apparatus 300 will be described. As shown in FIG. 1, the image forming apparatus 300 includes a CPU 301 configured to control each of blocks connected to a system bus 304 based on control programs stored in ROMs 302 and/or an external memory 303. An image signal generated through processing performed by the CPU 301 is output to a print unit (image-forming-apparatus engine) 306, as output information, via a print-unit I/F 305. Further, the CPU 301 can communicate with the host computer 100 via an input unit 307 and the network 10000, and can notify the host computer 100 of information or the like stored in the image forming apparatus 300.

A program ROM provided in each of the ROMs 302 stores a control program or the like of the CPU 301. A font ROM included in the ROMs 302 stores font data or the like used to generate output information. When the image forming apparatus 300 is not provided with the external memory 303 including a hard disk or the like, a data ROM included in the ROMs 302 stores information or the like used in the host computer 100.

A RAM 308 is a RAM functioning as the main memory, the work area, and so forth of the CPU 301. The memory capacity of the RAM 308 can be expanded by using an option RAM connected to an add-on port (not shown). Further, the RAM 308 is used as an output-information-expansion area, an environment-data storing area, a non-volatile RAM (NVRAM), and so forth.

Access to the external memory 303 is controlled by a memory controller (MC) 309. The external memory 303 is connected to the image forming apparatus 300, as an option, and configured to store font data, an emulation program, form data, and so forth. Further, an operation panel 311 includes switches, a light-emitting-diode (LED) display device, and so forth that are used to perform operations.

A scanner I/F 312 performs correction, processing, and editing for image data transmitted from a scanner unit 313. The scanner unit 313 converts information about an image shown on a document into electric signals by transmitting reflected light obtained by exposing and scanning the above-described image to a charge-coupled device (CCD). Further, the scanner unit 313 converts the electric signals into R, G, and B color brightness signals, and reads the brightness signals as image data.

When a user transmits an instruction to start reading data from the operation panel 311, a document read instruction is transmitted to the scanner unit 313. Upon receiving the instruction, the scanner unit 313 performs a document-read operation. The method of reading the document may be an automatic-feeding method set for a document feeder (not shown). Further, according to another method, a document may be placed on a glass plane which is not shown and an exposure unit is moved so that the document is scanned. An image forming apparatus 400 has the same configuration as that of the image forming apparatus 300.

In addition to the above-described image forming apparatuses, more information forming apparatuses are provided on the network. In the above-described embodiment, the image forming apparatuses include a facsimile, an ink-jet printer, a laser-beam printer, a scanner, and a multifunction peripheral (MFP) including the facsimile, the ink-jet printer, the laser-beam printer, and the scanner. Each of the various ROMs 302 and/or the external memory 303 stores destination information of the image forming apparatus 300. The image forming apparatus 300 transmits the destination information to a server 4000 as occasion arises. Similarly, the image forming apparatus 400 stores the destination information. The image forming apparatus 400 transmits the destination information to the server 4000 as occasion arises.

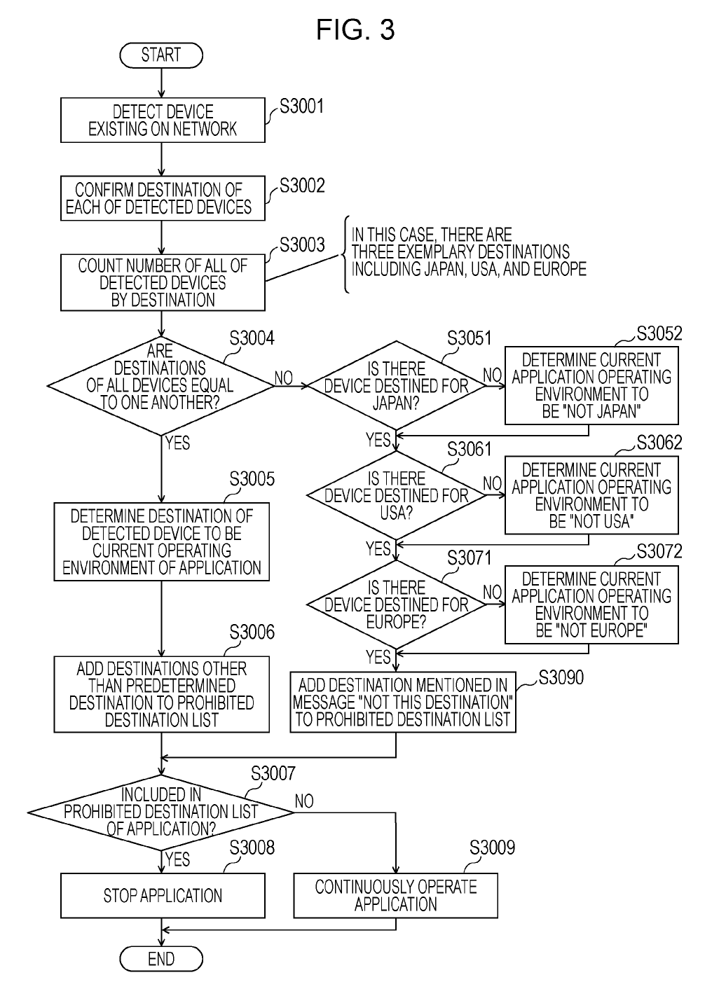

FIG. 2 is a module configuration diagram of the server 4000 according to the above-described embodiment. The server 4000 includes a communication unit 401, a device-destination determining unit 402, a destination-specific totalizing unit 403, an operating-environment determining unit 404, and a function-stop processing unit 405. When information about a destination (destination information) is transmitted from a device provided on the network to the communication unit 401, the function of the server 4000 is continuously operated and/or stopped in accordance with the destination of the device. Here, the server 4000 corresponds to the computer 100. The processing procedures shown in a flowchart of FIG. 3 are achieved through the functions shown in FIG. 2. The function-stop processing unit 405 is an exemplary function limiting unit.

As an example of function limitation, the function of a program may be entirely or partly stopped. In the case where a device management program is used, the function of the device management program may be limited as described below, for example. For example, the user is allowed to use the device-search function. The distribution function and/or various number-of-printing totalizing function of a device driver are stopped. Hereinafter, in another embodiment of the present invention, exemplary function stop will be described. However, the function limitation is applicable in another embodiment as is the case with the above-described embodiment.

FIG. 3 is a flowchart showing processing procedures performed according to the above-described embodiment, so as to acquire data of the destination of a device provided on the network, and continuously operate and/or stop the functions of the server in accordance with the destination of the device. Step S3001 is started when the communication unit 401 of the server is started, and/or when a search instruction is transmitted by an administrator and the communication unit of the server detects the search instruction.

At step S3001, the communication unit 401 of the server searches for a device existing on the network. According to the above-described embodiment, there are three destinations including Japan, USA, and Europe. However, actual destinations are not limited to the above-described three destinations. At step S3002, the device-destination determining unit 402 of the server may determine and confirm destinations of all devices detected at step S3001. At step S3002, the device-destination determining unit 402 may also optionally skip at least one of the devices detected at step S3001.

At step S3003, the destination-specific totalizing unit 403 of the server may totalize all of the detected devices for each destination based on the result of the determination made at step S3002.

At step S3004, the operating-environment determining unit 404 of the server divides the processing procedures based on the result of the totalization performed at step S3003. Namely, if the operating-environment determining unit 404 determines that the destinations of all of the devices are the same as one another, the processing advances to step S3005. If the operating-environment determining unit 404 determines that a device for a different destination is included in the above-described devices, the processing advances to step S3051.

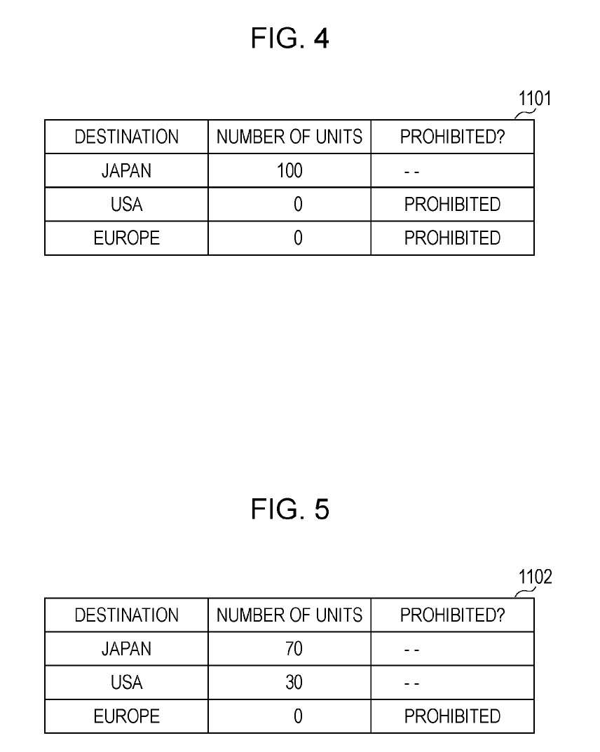

At step S3005, the operating-environment determining unit 404 of the server determines the same destination of the detected devices to be the current operating environment. At step S3006, the operating-environment determining unit 404 of the server determines destinations other than a predetermined destination to be destinations for which operation is prohibited and adds data of the above-described destinations to the list of prohibited destinations. If all of the devices are destined for Japan, the details of the list of the device number and the prohibited destinations are shown, as is the case with a list 1101 shown in FIG. 4.

At step S3051, the operating-environment determining unit 404 of the server confirms whether the data of the device destined for Japan is included in the totalization result obtained at step S3003. If the result of the confirmation shows that the data of the device destined for Japan is not included in the totalization result, the processing advances to step S3052. Otherwise, the processing advances to step S3061.

At step S3052, the operating-environment determining unit 404 of the server determines that the current operating environment is not Japan.

At step S3061, the operating-environment determining unit 404 of the server confirms whether the data of the device destined for the USA is included in the totalization result obtained at step S3003. If the result of the confirmation shows that the data of the device destined for the USA is not included in the totalization result, the processing advances to step S3062. Otherwise, the processing advances to step S3071.

At step S3062, the operating-environment determining unit 404 of the server determines that the current operating environment is not the USA.

At step S3071, the operating-environment determining unit 404 of the server confirms whether the data of the device destined for Europe is included in the totalization result obtained at step S3003. If the result of the confirmation shows that the data of the device destined for Europe is not included in the totalization result, the processing advances to step S3072. Otherwise, the processing advances to step S3090.

At step S3072, the operating-environment determining unit 404 of the server determines that the current operating environment is not Europe.

At step S3090, data of a destination which is not determined to be the current destination, as a result of the above-described determination, is registered with the list of the device number and the prohibited destinations, and the processing advances to step S3007. If there are devices destined for Japan and those destined for the USA at that time, the details of the list of the device number and the prohibited destinations are shown, as is the case with a list 1102 shown in FIG. 5.

At step S3007, the function-stop processing unit 405 of the server confirms whether an operation is prohibited for the destination of a server application in the list of the device number and the prohibited destinations. If the confirmation result shows that the destination of the server application is included in the prohibited destinations, the processing advances to step S3008 so that the function of the server is stopped. Otherwise, the processing advances to step S3009 so that the server application is continuously operated.

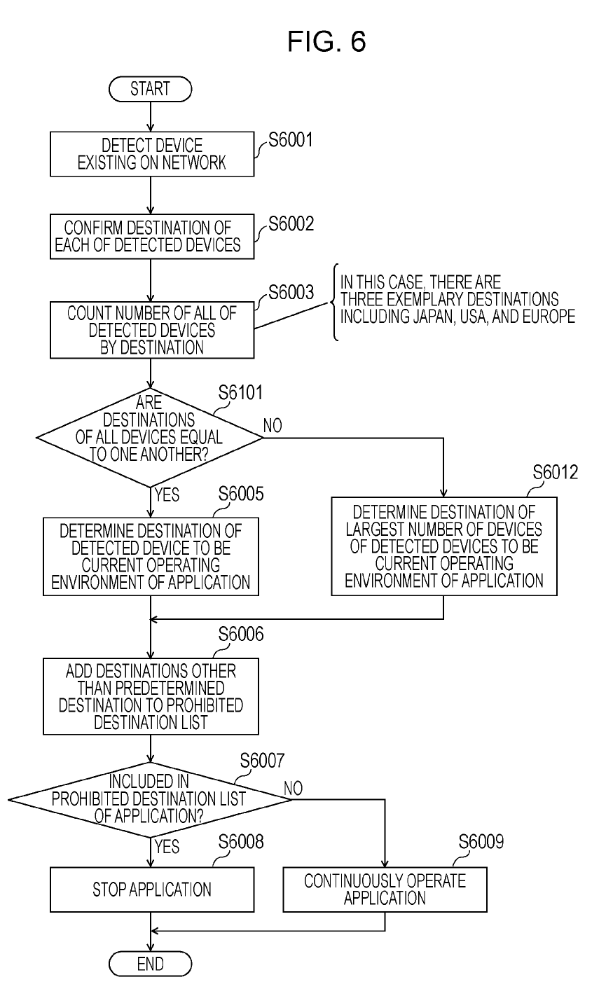

FIG. 6 is a flowchart of processing procedures performed according to a second embodiment of the present invention. According to the above-described processing procedures, the current operating environment is determined to be a destination to which the largest number of devices correspond. Then, the function of the server is continuously operated and/or stopped.

Here, the same parts as those of the first embodiment are omitted, and parts different from those of the first embodiment will be described. The processing procedures corresponding to the above-described different parts are also achieved through the functions shown in FIG. 2. For example, the processing procedures corresponding to S6001 to S6003, S6005, S6006, S6007, S6008, and S6009 are the same as those corresponding to S3001 to S3003, S3005, S3006, S3007, S3008, and S3009 of the first embodiment. The above-described processing procedures are also achieved through the functions shown in FIG. 2.

At step S6101, the operating-environment determining unit 404 of the server divides the processing based on the totalization result obtained at step S6003. Namely, if it is determined that the destinations of all of the devices are the same as one another, the processing advances to step S6005. If it is determined that a device for a different destination is included in the above-described devices, the processing advances to step S6012.

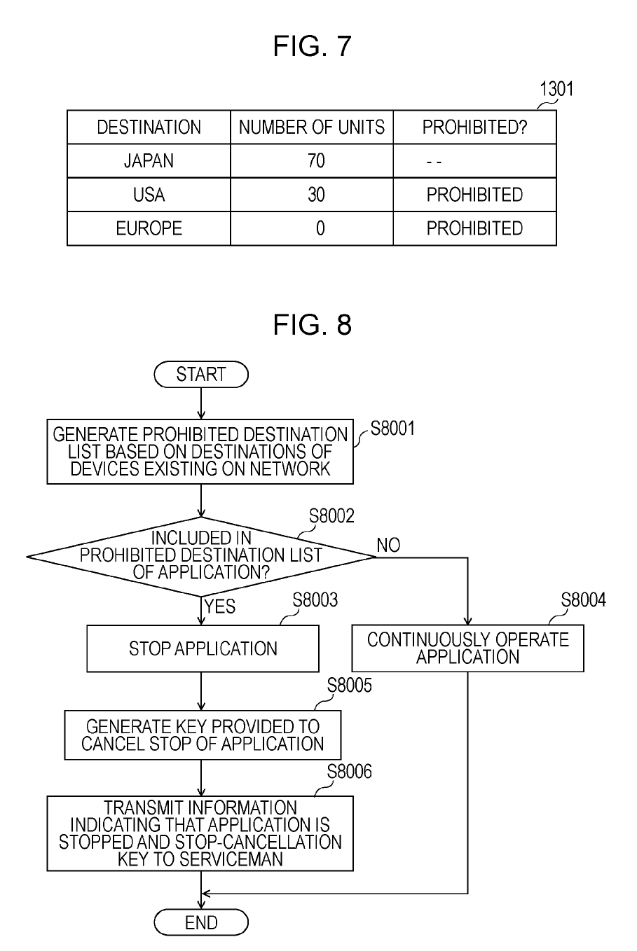

Of all of the detected devices, the operating-environment determining unit 404 of the server determines the destination of the largest number of devices to be the current operating environment at step S6012, and advances to step S6006. For example, if there are devices destined for Japan and those destined for the USA, and the devices destined for Japan outnumber those destined for the USA, the details of the list of the device number and the prohibited destinations are shown, as is the case with a list 1301 shown in FIG. 7.

FIG. 12 is a module configuration diagram of a server 2000 according to a third embodiment of the present invention. The server 2000 includes the communication unit 401, the device-destination determining unit 402, the destination-specific totalizing unit 403, the operating-environment determining unit 404, the function-stop processing unit 405, a cancellation-key generating unit 2001, and a function-restart processing unit 2002. When the function-stop processing unit 405 stops the functions of the server, the cancellation-key generating unit 2001 generates a key used to cancel the function stop. Upon receiving the cancellation key, the function-restart processing unit 2002 restarts the functions of the server. Data of the above-described modules is stored in the external memory 212 shown in FIG. 1. The module data is read and transmitted to the RAM 202, and executed by the CPU 201, for example.

FIG. 8 is a flowchart of processing procedures according to the third embodiment. When the functions of the server are stopped, data of a key used to restart the functions of the server is transmitted to a serviceman.

At step S8001, the operating-environment determining unit 404 of the server generates the list of prohibited destinations based on the destinations of devices existing on the network.

At step S8002, the function-stop processing unit 405 of the server determines whether data of the destination of the server application is included in the prohibited destination list generated at step S8001. If the determination result shows that the destination data is included in the prohibited destination list, the processing advances to step S8003. Otherwise, the processing advances to step S8004 so that the server is continuously operated.

At step S8003, the function-stop processing unit 405 of the server stops the functions of the server.

At step S8005, the cancellation-key generating unit 2001 of the server generates data of a key used to restart the server's functions stopped at step S8003.

At step S8006, the communication unit 401 of the server notifies a serviceman who had already been registered that the server's functions are stopped at step S8003, and transmits the key data generated at step S2001 to the serviceman. The destination of the notification is not limited to the serviceman. Further, the notification of the function stop and the key-data transmission may not be performed at the same time.

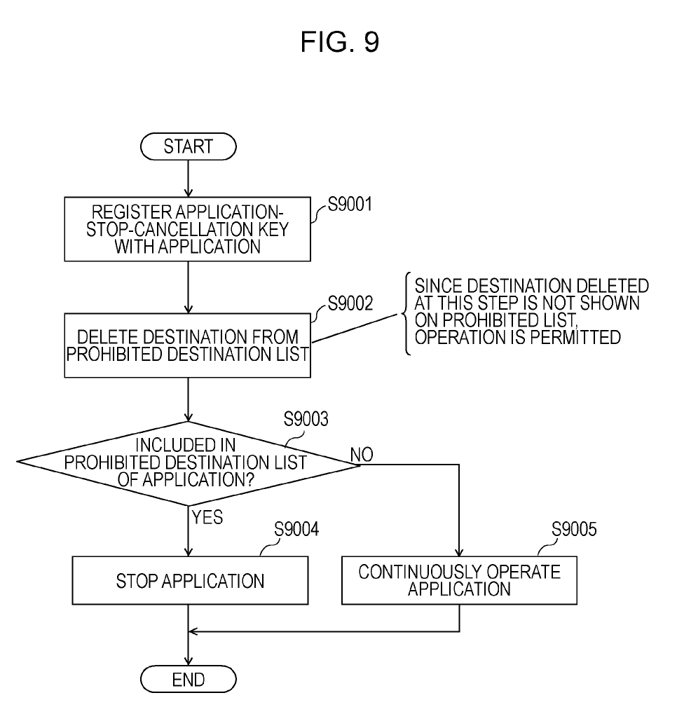

FIG. 9 is a flowchart of processing procedures performed according to the third embodiment, so as to restart the server's functions by using data of a stop cancellation key.

At step S9001, the server receives the key data generated at the above-described step S8005.

At step S9002, the function-restart processing unit 2002 of the server deletes data of the destination corresponding to the stop cancellation key, where data of the stop cancellation key is received at step S9001, from the prohibited destination list.

At step S9003, the function-restart processing unit 2002 of the server determines whether data of the destination of the server application is included in the prohibited destination list updated at step S9002. If the determination result shows that the destination data is included in the prohibited destination list, the processing advances to step S9004. Otherwise, the processing advances to step S9005.

At step S9004, the function-restart processing unit 2002 of the server stops the functions of the server and leaves the server in the stop state.

At step S9005, the function-restart processing unit 2002 of the server restarts the functions of the server.

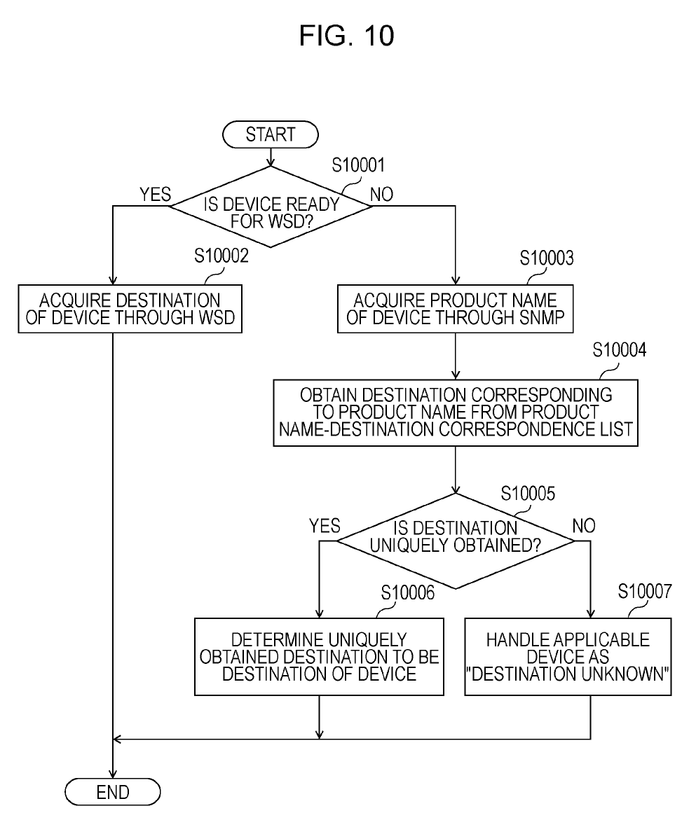

FIG. 10 is a flowchart of processing procedures performed according to a fourth embodiment of the present invention, so as to specify the destination of the device. Here, parts of the fourth embodiment, the parts being different from the above-described first embodiment, will be particularly described.

At step S10001, the device-destination determining unit 402 of the server determines whether a target device is ready for the Web Services on Devices (WSD) protocol. If the determination result shows that the target device is ready for the WSD protocol, the processing advances to step S10002. If the target device is not ready for the WSD protocol, the processing advances to step S10003.

At step S10002, the communication unit 401 of the server acquires data of the destination from the device by using the WSD protocol.

At step S10003, the communication unit 401 of the server acquires data of the product name of the device through a Simple Network Management Protocol (SNMP).

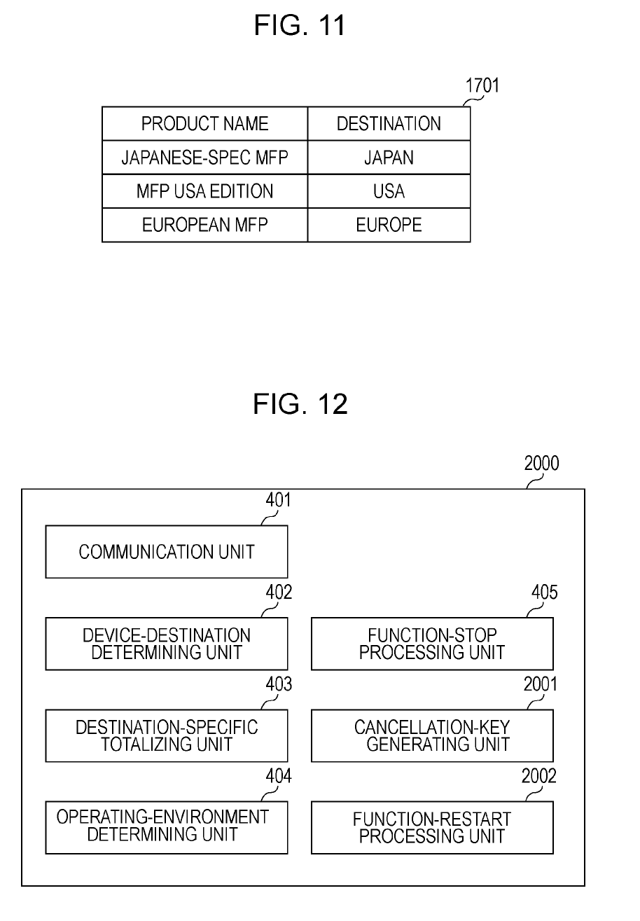

At step S10004, the device-destination determining unit 402 of the server acquires data of the destination corresponding to the product name of the target device from a product name-destination correspondence list 1701 shown in FIG. 11.

At step S10005, the device-destination determining unit 402 of the server determines whether the destination of the device can be uniquely specified based on the product name-destination correspondence list 1701. If the determination result shows that the destination is uniquely specified, the processing advances to step S10006. Otherwise, the processing advances to step S10007.

At step S10006, the device-destination determining unit 402 of the server determines the destination uniquely specified through the product name-destination correspondence list 1701 to be the destination of the target device.

At step S10007, the device-destination determining unit 402 of the server determines that the destination of the target device is an unknown destination.

According to the fourth embodiment, it becomes possible to specify the operating environment of an application, and start and stop the functions of the application in accordance with a specified operating environment without using an additional device such as a GPS terminal.

Further, the above-described embodiment allows for making the application operate appropriately in an environment in which reception of a GPS signal is difficult due to the characteristics of the GPS, where the environment may include a room, especially a basement, and so forth.

Thus, the computer 100 (server), which is an exemplary information processing apparatus communicating with the image forming apparatus 300, which is an exemplary image forming apparatus, has been disclosed.

The NC 212 receives the destination information transmitted from the image forming apparatus 300.

The destination of the image forming apparatus 300 is determined based on the destination information transmitted to the NC 212. The CPU 201 is an exemplary destination determining unit. According to the above-described embodiment, the destination information includes identification information indicating Japan, USA, Europe, etc., and identification information indicating areas, cities, and so forth including Hokkaido, Okinawa, the Honshu island, Nara, Kyoto, Tokyo, etc. The identification information may indicate locations, place-names, and so forth. Otherwise, the identification information may be any information indicating the destination of a device.

The CPU 201 totalizes the number of the image forming apparatuses which become the destinations determined by the CPU 201.

The CPU 201 determines the current operating environment based on the totalization result.

The CPU 201 stops the functions of a program presented to the image forming apparatus based on a result of the above-described determination.

The CPU 201 totalizes the number of printed outputs for each of the image forming apparatuses (300 and 400) connected to the network for each of destinations to which the image forming apparatuses belong. Then, the CPU 201 may determine that the destination corresponding to the largest number of totalized printed outputs agrees with the current environment.

Further, when the image forming apparatus connected to the network, which is determined through the destination determining processing, is not ready for the WSD protocol, it may be arranged that information about the image forming apparatus can be acquired through the SNMP. Then, the computer 100 may include a destination correspondence list showing the correspondence between information that can be acquired through the SNMP and destinations. Further, the computer 100 may determine the destination corresponding to information acquired through the SNMP to be the destination of the image forming apparatus by using the destination correspondence list. Then, the above-described destination correspondence list may retain data of the correspondence between the product name and the destination of the image forming apparatus. The product name-destination correspondence list 1701 is an example of the above-described destination correspondence list.

If it is difficult for the CPU 201 to uniquely determine the destination of the image forming apparatus 300, even though the CPU 201 refers to the destination correspondence list, the CPU 201 may determine that the destination of the image forming apparatus 300 is unknown.

Further, the computer 100 may generate data of a cancellation key used to cancel the function stop when the functions are stopped through the function stop processing.

The stopped functions may be restarted by registering the generated cancellation key data.

The above-described cancellation key data may be transmitted to a predetermined address. The NC 212 may be an exemplary transmission unit.

The CPU 201 may totalize the operating time of each of the image forming apparatuses connected to the network on a destination-by-destination basis. Further, the CPU 201 may determine that the destination of the image forming apparatus corresponding to the longest totalized operating time agrees with the current environment based on a result of the destination-by-destination totalization.

The above-described embodiment allows for making an application operate appropriately in the operating environment without using an additional GPS device used to detect position information, so as to specify the operating environment of the application.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2008-155356 filed on Jun. 13, 2008, which is hereby incorporated by reference herein in its entirety.

What is claimed is:

1. An information processing apparatus configured to communicate with an image forming apparatus, the information processing apparatus comprising:
a receiving unit configured to receive destination information transmitted from the image forming apparatus;
a destination determining unit configured to determine a destination of the image forming apparatus by using the destination information received by the receiving unit;
a totalizing unit configured to totalize a number of image forming apparatuses associated with the determined destination;
an operating-environment determining unit configured to determine a current operating environment based on the number of image forming apparatuses totalized by the totalizing unit; and
a function limiting unit configured to limit at least one function of a program presented to the image forming apparatus based on the current operating environment determined by the operating-environment determining unit.

2. The information processing apparatus according to claim 1,
wherein the totalizing unit totalizes a number of printed output of each of a plurality of image forming apparatuses connected to a network for each destination to which the image forming apparatuses belong, and
wherein the operating-environment determining unit determines a destination corresponding to a largest number of printed outputs totalized by the totalizing unit to be the current operating environment.

3. The information processing apparatus according to claim 1,
wherein when the image forming apparatus which becomes a determination target for the destination determining unit is not ready for a Web Services on Devices protocol, the destination determining unit acquires information about the image forming apparatus through a Simple Network Management Protocol (SNMP),
wherein the information processing apparatus includes a destination correspondence list showing a correspondence between information that can be acquired through the SNMP and the destination, and
wherein the destination determining unit determines a destination corresponding to the information acquired through the SNMP to be a destination of the image forming apparatus by using the destination correspondence list.

4. The information processing apparatus according to claim 3, wherein the destination correspondence list retains data of a correspondence between a product name and the destination of the image forming apparatus.

5. The information processing apparatus according to claim 3, wherein when it is difficult for the destination determining unit to determine the destination of the image forming apparatus even though the destination determining unit refers to the destination correspondence list, the destination determining unit determines that the destination is unknown.

6. The information processing apparatus according to claim 1, further comprising:
a cancellation-key generating unit configured to generate data of a cancellation key provided to cancel the function limitation when the function is stopped by the function limiting unit; and
a function restart processing unit configured to restart the stopped function by registering the generated cancellation key data.

7. The information processing apparatus according to claim 6, further comprising:
a transmitting unit configured to transmit the generated cancellation key data to a predetermined address.

8. The information processing apparatus according to claim 1,
wherein the totalizing unit totalizes operation time of each image forming apparatus connected to a network on a destination-by-destination basis, and
wherein the operating-environment determining unit determines a destination of an image forming apparatus corresponding to a longest totalized operation time to be the current operating environment based on the totalization performed on the destination-by-destination basis.

9. A method used for an information processing apparatus configured to communicate with an image forming apparatus, the method comprising:
receiving destination information transmitted from the image forming apparatus;
determining a destination of the image forming apparatus by using the destination information received from the image forming apparatus;
totalizing a number of image forming apparatuses associated with the determined destination;
determining a current operating environment based on the number of image forming apparatuses associated with the determined destination; and
stopping at least one function of a program presented for the image forming apparatus based on the current operating environment determined.

10. The method used for the information processing apparatus according to claim 9,
wherein, at totalizing, a number of printed output of each of a plurality of image forming apparatuses connected to a network is totalized for each destination to which the image forming apparatuses belong, and
wherein, at the determination of the current operating environment, it is determined that a destination corresponding to a largest number of printed outputs totalized corresponds to the current operating environment.

11. The method used for the information processing apparatus according to claim 9,
wherein, at determining the destination, when the image forming apparatus which becomes a determination target is not ready for a Web Services on Devices protocol, information about the image forming apparatus is acquired through a Simple Network Management Protocol (SNMP),
wherein the information processing apparatus includes a destination correspondence list showing a correspondence between information that can be acquired through the SNMP and the destination, and
wherein, at determining destination, a destination corresponding to the information acquired through the SNMP is determined to be a destination of the image forming apparatus based on the destination correspondence list.

12. The method used for the information processing apparatus according to claim 11, wherein the destination correspondence list retains data of a correspondence between a product name and the destination of the image forming apparatus.

13. The method used for the information processing apparatus according to claim 11, wherein when it is difficult, at determining destination, to determine the destination of the image forming apparatus even though the destination correspondence list is referred to, it is determined that the destination is unknown.

14. The method used for the information processing apparatus according to claim 9, the method further comprising:
generating data of a cancellation key provided to cancel the function limitation when the function is stopped; and
restarting the stopped function by registering the generated cancellation key data.

15. The method used for the information processing apparatus according to claim 14, the method further comprising:
a transmitting step provided to transmit the generated cancellation key data to a predetermined address.

16. The method used for the information processing apparatus according to claim 9,
wherein, at totalizing, operation time of each image forming apparatus connected to a network is totalized on a destination-by-destination basis, and
wherein, at the determination of the current operating environment, a destination of an image forming apparatus corresponding to a longest totalized operation time is determined to be the current operating environment based on the totalization performed on the destination-by-destination basis.

17. A computer readable recording medium storing a control program provided to make a computer execute a method used for an information processing apparatus comprising:
receiving destination information transmitted from the image forming apparatus;
determining a destination of the image forming apparatus by using the destination information received from the image forming apparatus;
totalizing a number of image forming apparatuses associated with the determined destination;
determining a current operating environment based on the number of image forming apparatuses associated with the determined destination; and
stopping at least one function of a program presented for the image forming apparatus based on the current operating environment determined.
